(19) United States
(12) Patent Application Publication
(10) Pub. No.: US 2017/0165867 A1
(43) Pub. Date: Jun. 15, 2017

(54) BI -MATERIAL DIE AND METHOD FOR EXTRUDING ABRASIVE EXTRUDABLE MATERIALS

(71) Applicant: DOW GLOBAL TECHNOLOGIES LLC, Midland, MI (US)

(72) Inventors: Nestor A. Vasquez, Shepherd, MI (US); Jeffery D. Zawisza, Midland, MI (US); Douglas D. Merrick, Midland, MI (US)

(21) Appl. No.: 15/444,459

(22) Filed: Feb. 28, 2017

Related U.S. Application Data
(63) Continuation of application No. 14/431,395, filed on Mar. 26, 2015.
(60) Provisional application No. 61/730,090, filed on Nov. 27, 2012.

(51) Int. Cl. B28B 3/26; B30B 11/22; B01D 46/00; C04B 38/00; B28B 7/34; B01D 46/24

(52) U.S. Cl. CPC B28B 3/269; B28B 7/34; B01D 46/2418; B01D 46/0001; C04B 38/0006; B30B 11/221

(57) ABSTRACT

An article comprising a) a die core having a plurality of flow paths adapted to flow extrudable material to a plurality of slots including wall slots and skin slots and around a plurality of pins so as to form a honeycomb structure from the extrudable material; and b) a mounting plate adapted to hold the die core in an extrusion system having an opening adapted to allow the extrudable material passed through the die core to exit, an outer portion adapted to mount and hold the die core in place, a flange about the periphery of the opening which seats the die core, an inner surface disposed to partially form the skin slots adapted to allow extrudable material to flow from the skin slots to form the skin of the honeycomb structure; and wherein the die core and mounting plate are comprised of different materials having different wear properties.

### FIELD OF THE INVENTION

The present invention relates generally to bi-material die for extrusion of abrasive extrudable materials and to processes for extruding structures from abrasive material, such as honeycomb structures. The present invention also relates to a system for extruding honeycomb structures comprising the bi-material die.

### BACKGROUND OF THE INVENTION

Ceramic based honeycomb filters are utilized for filtering particulate matter from fluid streams, for example solids from liquids, such as beer, and gaseous streams, from exhaust streams. Ceramic based honeycombs are prepared by forming an extrudable mixture of precursor materials; extruding the mixture through a die to form a wet ceramic honeycomb precursor; drying the ceramic honeycomb precursor; removing any organic binders, porogens and processing aids by burning them out of the mixture at elevated temperatures, and then processing the remaining materials to form a ceramic; structure. The extrudable mixture contains particles of materials needed to form coherent ceramic parts, for examples alumina, silica, particles and the like. The presence of these particles in the extrudable mixture renders the mixture abrasive and significant wear of extrusion systems, including dies, is experienced in the extrusion of these mixtures.

Ceramic based honeycomb filters are prepared with skins on the outer surface, parallel to the extrusion direction. The skins are typically thicker than the walls of the honeycomb structure to protect the honeycomb filters from damage during normal use and handling of the honeycomb filters. To form a skin thicker than the walls, a thicker stream of extrudable material needs to be processed. In some instances this thicker stream of extrudable material can flow faster than the material forming the walls of the honeycomb mixture. To balance the flow of extrudable material between the skin formation section and the wall formation section, it is common practice to use a plate behind the die to cover a portion of the feed holes used to provide extrudable material for the skin to slow down the flow of the portion of extrudable material used to form the skin, see for example US 2009/0028982 and US 2010/0301514 incorporated herein by reference. As discussed above the extrudable materials are abrasive and wear the die materials. It is common to use hardened steel for the die components so that the dies have a longer life and can process more material. The wear on the surfaces of certain materials, such as hardened steel, can cause the surface to become rougher and as a result become more resistant to flow of the extrudable materials. In some situations the resistance to flow can cause different portions of the extrudable material to flow at different rates. This can result in the extruded articles in having defects which result in the articles being incapable of performing their function. Differences in flow can cause defects in the skin and in extreme instances can cause the skin to peel away from the extruded wall portion of the ceramic honeycomb precursors. Some processes utilize complex skin material flow paths to address this issue, see US Applications described above, and some others utilize dies with coatings on all of the die, see U.S. Pat. No. 7,132,124 incorporated herein by reference. These solutions fail to directly address the difference in wear due to the differences in flow in the wall formation and skin formation sections of the die.

Thus, what is needed is a die system, extrusion system and method of extruding honeycomb filter precursors which directly addresses the difference in flow due to uneven roughness as a result of the wear process. What are needed is such systems and methods that allow for prolonged use of the dies and high yield rates of ceramic honeycomb filter precursors.

### SUMMARY OF THE INVENTION

The present invention relates to an article comprising: a) a die core having a plurality of flow paths adapted to flow extrudable material to a plurality of slots and around a plurality of pins so as to form a honeycomb structure from the extrudable material, the honey comb structure having a skin about its outer surface in the extrusion direction, the slots comprise wall slots for forming walls of the honeycomb structure and skin slots disposed about an outer periphery of the die core for forming the skin around the honeycomb structure, the die having an extrusion entrance surface and an extrusion exit surface; b) a mounting plate adapted to hold the die core in an extrusion system having an opening adapted to allow the extrudable material passed through the die core to exit the die core, an outer portion adapted to mount and hold the die core in place, and a flange about the periphery of the opening which seats the die core and is disposed about the outer periphery of the extrusion exit surface of the die core, wherein the inner surface of the mounting plate is disposed to partially form the skin slots adapted to allow extrudable material to flow from the skin slots to form the skin about the outer surface of the honeycomb structure; wherein the die core and the mounting plate are comprised of different materials having different wear properties. Preferably, the surface of the mounting plate in contact with the extrudable material has a surface roughness of about 10 percent or greater less than the surface roughness of the die core material. In some embodiments, the die core comprises different material from the material used for the mounting plate. In some embodiments, the die core comprises hardened tool steel, and the mounting plate comprises stainless steel, tungsten carbide or titanium carbide. In some embodiments the mounting plate has a coating disposed on its outer surface. In some embodiments, the coating disposed on the outer surface of the mounting plate comprises one or more of a metal, metal alloy, polymer and ceramic. In some preferred embodiments the coating disposed the outer surface of the mounting plate exhibits a thickness of about 0.0002 inches (0.005 mm) to about 0.005 inches (0.013 mm). In a preferred embodiment, the article according to the invention is capable of extruding 10.000 meters of honeycomb structure.

In some embodiments, the invention is a system comprising an extrusion apparatus and a die assembly of the invention wherein an extrudable material can be extruded through the die core. Preferably the systems of the invention further comprise a cutting apparatus which cuts the extruded honeycomb mass to a desired length.

In some embodiments, the invention is a method comprising providing an extrusion system of the invention and extruding an extrudable material which is abrasive through the die core to form a honeycomb structure. In some embodiments, the method further comprises cutting the extruded honeycomb structure to a desired length.

The articles, systems and methods of the invention allow for preparing ceramic honeycomb filter precursors in high yield using dies having extended lifetimes. The articles, systems and methods of the invention do not require complex flow paths or expensive coatings on the entire die system.

### DESCRIPTION OF THE DRAWINGS

FIG. 1 is a die core form the perspective of the extrusion exit surface.

FIG. 2 is a mounting plate from the perspective of the extrusion feed side.

FIG. 3 is a cut away though a center of a die assembly of the invention.

FIG. 4 is a portion of the cut away view of FIG. 3 showing skin slots and the skin forming surface.

FIG. 5 is a cut away though a center of a second embodiment of a die assembly of the invention.

FIG. 6 is a portion of the cut away view of FIG. 5 showing skin slots and skin forming surface of the invention.

FIG. 7 shows the extrusion feed surface of two die cores of different materials.

FIG. 8 shows the extruded honeycomb ceramic filter precursor exiting an extrusion die with a mounting plate having a skin flow surface of hardened tool steel.

FIG. 9 shows extruded segments prepared using a die of the invention.

FIG. 10 shows the extruded segments being cut.

### DETAILED DESCRIPTION

The explanations and illustrations presented herein are intended to acquaint others skilled in the art with the invention, its principles, and its practical application. The specific embodiments of the present invention as set forth are not intended as being exhaustive or limiting. The scope of the invention should be determined with reference to the appended claims, along with the full scope of equivalents to which such claims are entitled. The disclosures of all articles and references, including patent applications and publications, are incorporated by reference for all purposes. Other combinations are also possible as will be gleaned from the following claims, which are incorporated by reference into this written description. This application claims priority from provisional application Ser. No. 61/730,090, filed 27 Nov. 2012, incorporated herein by reference in its entirety.

The invention relates to dies useful in extruding ceramic precursor material, extrudable material, into a honeycomb structure having a protective skin about the exterior surface of the honeycomb structure. The invention further relates to extrusion systems comprising the dies of the invention wherein the systems are useful in extruding and forming ceramic honeycomb filter precursors. As used herein precursors refer to material that can be further processed into ceramic honeycomb filters. The invention further relates to methods of forming the ceramic honeycomb filter precursors using the dies of the invention. One or more as used herein means that at least one, or more than one, of the recited components may be used as disclosed. Extrudable material means a material that can be shaped by passing the material through a die and which can retain the shape formed after passing through the die. Abrasive extrudable material material is material that can be extrudable which contains abrasive element such as silica, alumina, silicon carbide particles and the like.

The die of the invention comprises a die core and a mounting plate. The die core functions to form a shaped article from extrudable material, preferably abrasive extrudable material. The die core has two opposing surfaces, one for introduction of an extrudable material into the die, extrudable material introduction surface, and one from which the extruded material exits, extrusion exit surface. On the extrudable material introduction surface of the die is a plurality of holes adapted for the introduction of extrudable material to the die. Each of the holes communicates with a flow passage for moving extrudable materials to slots formed by pins which form the extruded structures. Thus there is a plurality of flow paths. The die further comprises a plurality of pins attached to the die wherein the pins form a plurality of slots through which the extrudable material flows to form the desired structure, preferably a honeycomb structure. Preferably the slots are disposed such that there is a first set of plurality of slots disposed parallel to one another, preferably evenly spaced apart and a second set of a plurality of slots disposed parallel to one another, and preferably evenly spaced apart, and perpendicular to the first set of slots. The combination of the two sets of slots act to form a honeycomb structure. The plurality of flow paths communicate with the slots so as to feed extrudable material to the slots. There are two types of slots wall forming slots which are adapted to form the walls of the honeycomb structure, wall slots. The second set of slots are adapted to form the outside skin of the honeycomb structure, skin slots. The skin slots are disposed about the periphery of the die core, the outside slots of the die core. The wall slots are the slots disposed inside of the skin slots. It is the combination of the pins and the slots formed by the pins that form the honeycomb structure. The wall and skin slots may be of the same thickness or of different thickness. Preferably the skin slots are thicker than the wall slots so as to form a skin which is thicker than the walls. This is to prepare a skin which is of sufficient thickness to protect the ceramic honeycomb filters from damage due to handling and assembly loads. The thickness of the skin and the walls will vary with the design of the honeycomb filters. In some preferred embodiments the thickness of the skin is about 1.1 times (×) the nominal thickness of the inner walls or greater and more preferably 1.25× the nominal thickness of the inner walls or greater. Preferably the thickness of the skin is about 2.0× the nominal thickness of the inner walls or less and more preferably about 1.5× the nominal thickness of the inner walls or less. In some preferred embodiments the thickness of the walls is about 1.3× the nominal thickness of the inner walls or greater and more preferably 1.4× the nominal thickness of the inner walls or greater.

The die core may further comprise a flange about the periphery of the die core adapted to cooperate with a flange on the mounting plate to hold the die core in place in the extrusion system. The flange preferably has surface parallel to the extrusion face of the die core which is recessed so as to cooperate with the mounting plate flange.

The die core is comprised of a material that can retain its functional shape for an extended period of time to avoid frequent replacement of the die core. The complex geometry of the die core is expensive to fabricate thus it is desirable to utilize a die core for extended periods of time and to use the die core to prepare a significant amount of ceramic honeycomb precursor material. This can be measured in linear lengths of ceramic precursor formed, in meters or feet. Any material that can retain its shape for the desired life may be used. Exemplary materials include hardened tools steel, tungsten carbide, stainless steel, and the like. More preferably the materials are hardened tool steel, tungsten carbide and the like.

The die core further comprises a mounting plate which functions to hold the die core in place in an extrusion system. The mounting plate further forms an outside skin flow surface. The skin flow surface forms the outside surface of the skin in cooperation with the outside pins of the die core. The skin flow surface is typically parallel to the plane formed by the surface of the outside pins. The mounting plate contains mounting features for affixing die to an extrusion apparatus. The mounting features must provide sufficient strength to hold the die in place during extrusion. The mounting plate further comprises a central opening adapted to allow extruded material to exit from the exit surface of the die core. About the periphery of the opening is a flange adapted to work with the flange of the die core to hold the die in place. The two flanges may abut to one another when assembled or intermediate parts may be located between the flanges. In some embodiments the skin flow surface is disposed about periphery of the opening in the mounting plate parallel to the extrusion direction and perpendicular to the die core exit surface. The mounting features of the mounting plate may be any mounting feature capable of holding the die in place and withstanding the pressure applied during extrusion. Exemplary mounting features include bolt holes, threaded bolt holes, and external locking ring systems and the like. The mounting plate can comprise any material that allows it to perform the recited functions. It may be a single material, comprise two materials or comprise two parts of different material. The skin flow surface is comprised of a material that allows the extrudable material used to form the skin to flow with the minimum amount of resistance to flow. The mounting plate may comprise one of more of the following materials; stainless steel, tungsten carbide, and titanium carbide, and the like. In one embodiment, the mounting plate comprises a single material. In another embodiment the mounting plate has at least two parts, wherein one forms a flow surface that can be replaced which is in contact with the extrudable material. Most preferably the mounting plate comprises a stainless steel, tungsten carbide, titanium carbide and most preferably stainless steel. The flow surface can be a coating or an insert prepared from a material that does not become resistant to flow with use.

In one embodiment, the mounting plate can comprise an insert disposed between the inner surface of the flange and the skin slot, the insert providing the skin flow surface. The skin flow surface of the mounting plate or insert can have a structure adapted to funnel the extrudable materials from the flow channels to the skin slot. Such structure can include a chamfer, single or multiple radii and the like. Where the flow surface is formed on an insert in the mounting plate, the insert is preferably formed from stainless steel, tungsten carbide, titanium carbide or a ceramic material, with tungsten carbide, titanium carbide more preferred.

The die may further include an internal breaker plate to introduce a structure adapted to funnel the flow of extrudable material to the skin forming slots. An internal breaker plate can be disposed between the flanges of the mounting plate and the die core. The die may include a breaker plate on the extrusion entrance surface adapted to control the flow of extrudable material, particularly to the skin slots. Spacer plates may be added to adjust the die to accommodate the addition of inserts or internal breaker plates.

To form an acceptable skin about the surface of the ceramic honeycomb precursor the amount of extrudable material used for the skin and processed through the skin slots is more than processed through the wall slots. This difference in amount can cause problems in the formation of the skin layer. Also resistance to flow of the extrudable material through the skin slots can create problems in formation of an acceptable skin layer. The material used for the skin flow surface needs to provide low resistance to flow of the extrudable material. Thus a material that is or can become relatively smooth, that is have a low surface roughness is preferable for use as the mounting plate or the surface of the mounting plate that forms the skin flow surface. It is desirable to use a material for the mounting plate or skin flow surface that maintains (does not increase) its surface roughness or experiences a decrease in surface roughness during extrusion. After about 100 to 500 meters of extrusion the surface roughness of the skin forming surface should become relatively constant. After this point the surface roughness as defined as the density of summits should be about 0.0025 peaks/μm² or less, more preferably about 0.0022 peaks/μm² or less and most preferably about 0.0013 peaks/μm² or less. The difference in surface roughness between the skin flow surface and the surface of the die core material is preferably about 10 percent or greater and more preferably about 25 percent or greater. The difference in surface roughness between the skin flow surface and the surface of the die core material is preferably about 95 percent or less and more preferably about 90 percent or less.

The die of the invention can be used in an extrusion system useful in extruding abrasive extrudable materials. Such systems are well known in the art and include extruders for extruding materials wherein the materials are passed through the die under pressure. Exemplary extrusion systems include screw and ram based extruders.

The dies of the invention are used in processes for extruding extrudable materials, preferably abrasive extrudable materials to prepare ceramic honeycomb filter precursors. Preferably the ceramic honeycomb precursors comprise a plurality of walls and passages in the extrusion direction and exhibit a polygonal shape in the planes perpendicular to the extrusion direction having flat outside surfaces. More preferably the cross-sectional shape is rectangular or square and most preferably square. In a preferred embodiment the ceramic honeycomb precursors are designed to be used as segments which are assembled to prepare arrays of ceramic honeycomb segments. In some embodiments these arrays are shaped to form different cross-sectional shapes, such as circular or oval.

In the process the extrudable material is prepared by mixing the precursor material as known in the art, see for example EP 1 657 039 B1, incorporated herein by reference. The extrudable material is passed through an extruder and then extruded under pressure through the die to form a continuous honeycomb product. After extrusion the mass is cut to form ceramic honeycomb filter precursors of the desired length. The flow rate and pressures utilized are size and equipment dependent and one skilled in the art of extrusion can determine appropriate parameters for the process. The cutting apparatus can be any cutting system that does not collapse the walls of the ceramic honeycomb precursor. The formed ceramic honeycomb precursors can be dried, subjected to conditions to remove (burnout) organic materials, subjected to conditions to sinter the remainder of the materials to form ceramic structures and optionally to processes to alter or improve the structure of the formed ceramic structures see for instance US 2010/0218 472 A1, incorporated herein by reference.

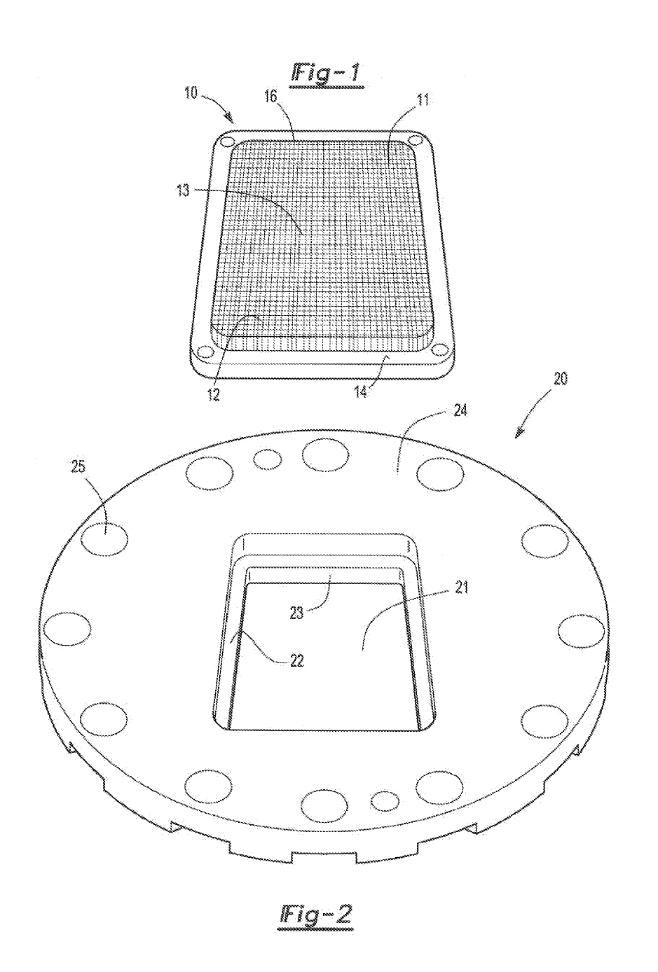

FIG. 1 shows a die core 10 from the perspective of the extrusion exit surface 13. Shown is a plurality of pins I 1 projecting toward the extrusion exit surface 13. The pins 11 form a plurality of wall forming slots 12 and skin forming slots 16. Also shown is a flange 14 about the periphery of the die core 10. FIG. 2 shows a mounting plate 20 from the perspective of the extrusion feed side 24 adapted to be used with the die core of FIG. 1. Shown is an opening 21 in the mounting plate 20 adapted for receiving the die core 10, not shown. The mounting plate 20 has a flange 22 for holding the die core 10 (not shown) to an extruder (not shown). The inside surface of the opening 21 forms the skin flow surface 23. On the extrusion feed surface 24 are a number of holes 25 adapted for receiving bolts to affix the die to an extruder (not shown).

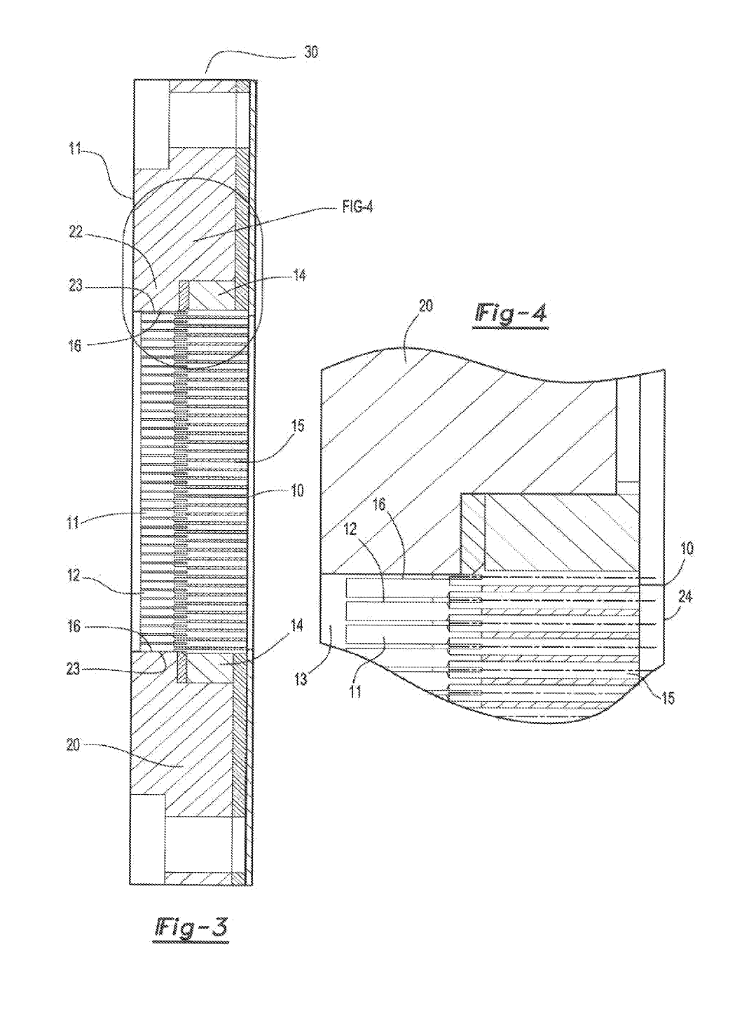

FIG. 3 is a cut away though a center of a die assembly of the invention 30. Shown is the die core 10 assembled with the mounting plate 20 with their respective flanges 14 and 22 abutted to one another. Shown are flow paths (holes) 15 adapted to flow extrudable material to the wall flow slots 12 and the skin flow slots 16 around pins 11. The skin flow surface 23 of the mounting plate 20 is shown. FIG. 4 is a portion of the cut away view of FIG. 3 showing skin slots 16 and skin forming surface 13. Also shown are extrudable material flow paths 15, the die core 10 and the mounting plate 20.

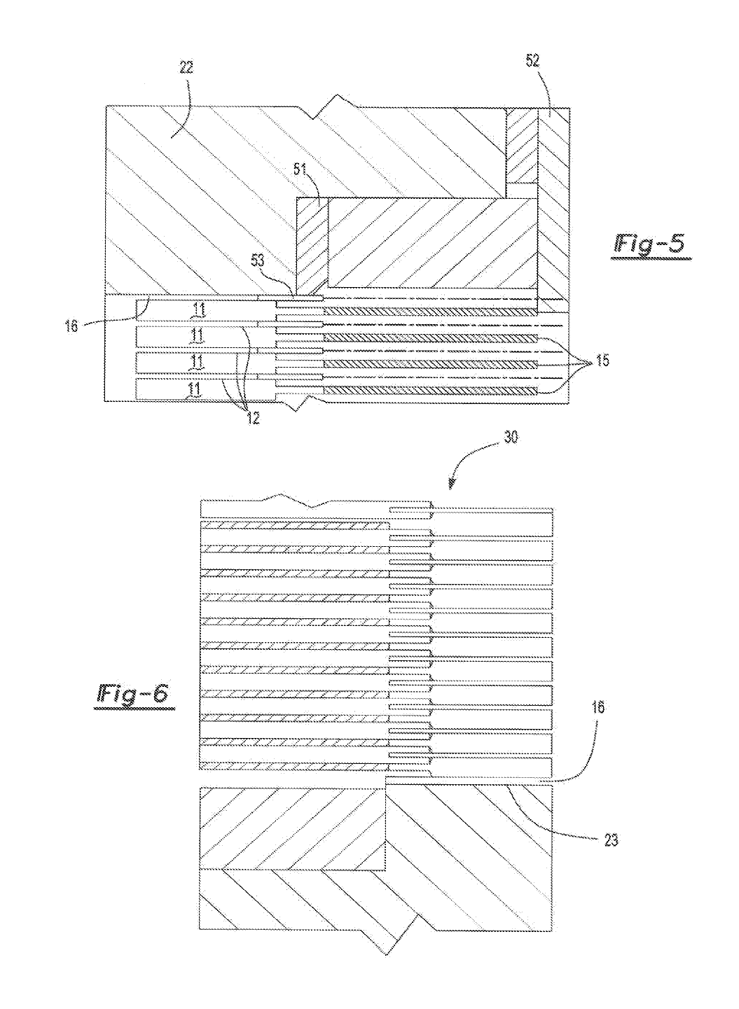

FIG. 5 is a cut away view showing skin slots and skin forming surface of the second embodiment of the invention. Added are an internal break plate 51 having a flow enhancer 53 in the form of a chamfer of 45 degrees. Also shown is an external breaker plate, 52. This is exemplary.

FIG. 6 is a cut away though a center of a second embodiment of a die assembly 30 of the invention, showing the skin slots 16 and the skin flow surface 23.

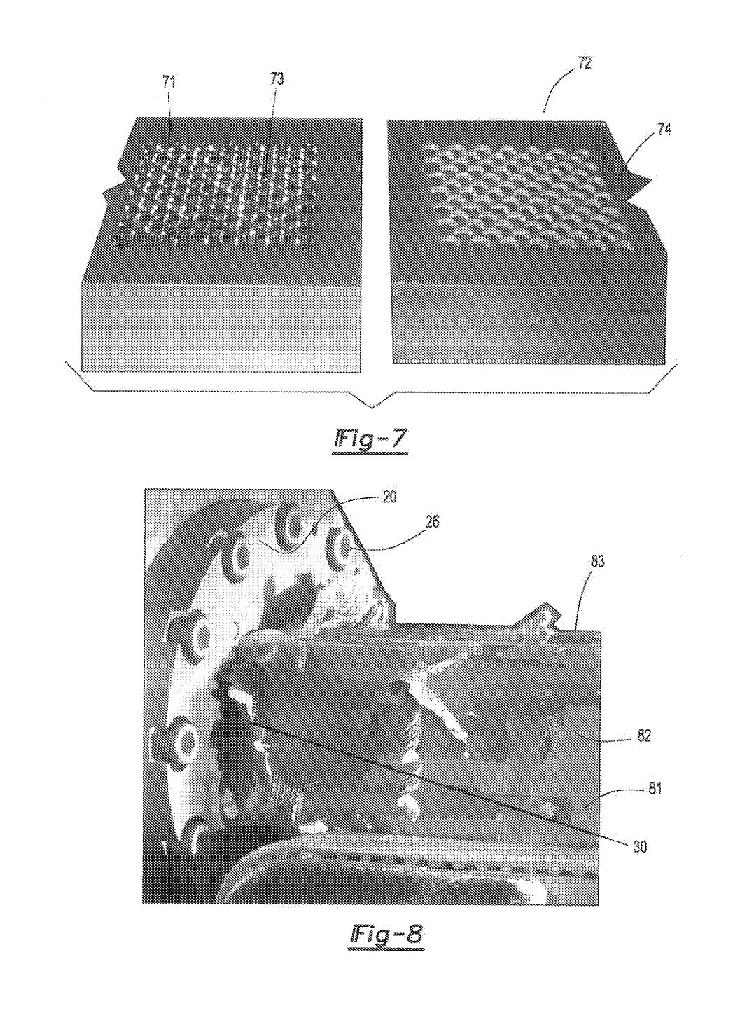

FIG. 7 shows the extrusion feed surface of two die cores of different materials. The first core 71 shows a plurality of feed holes. The material about the feed holes 73 is shiny because the die core is prepared from stainless steel and through the process of extrusion the stainless steel surface became polished thereby reducing the surface roughness. Die core 72 is comprised of hardened tool steel and the material about the feed holes 74 has a dull look due to the increased surface roughness as a result of extrusion of abrasive extrudable material.

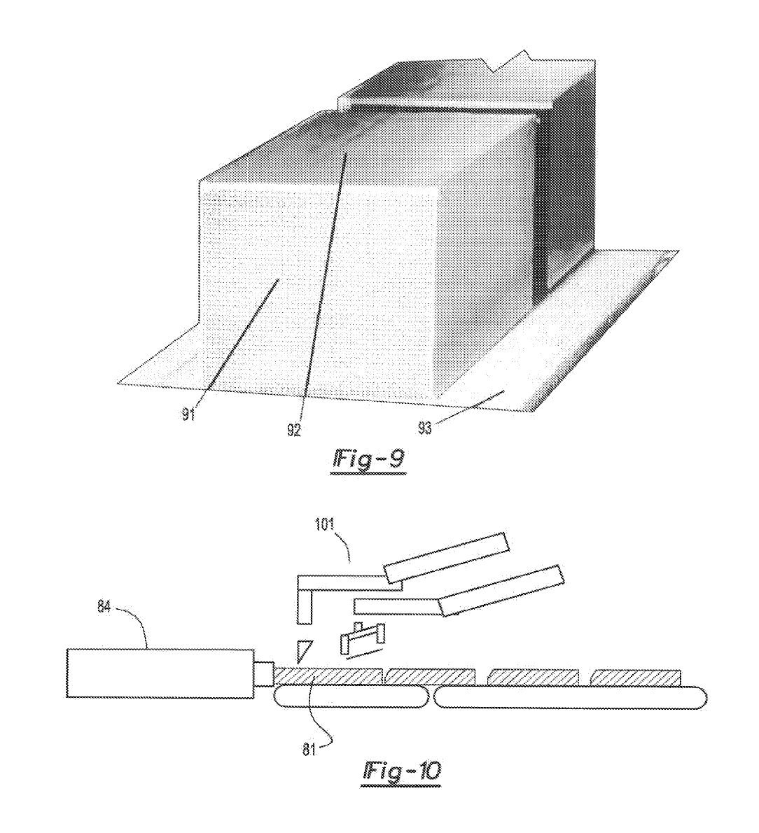

FIG. 8 shows an extruded honeycomb ceramic filter precursor 81 exiting an extrusion die 30 of an extruder 84 with a mounting plate 20 having a skin flow surface of hardened tool steel. The skin 82 shows one a number of portions peeling 83. The mounting plate 20 is made from hardened tool steel. Also shown are bolt heads 26 holding the die 30 into the extruder 84. FIG. 9 shows extruded cut ceramic honeycomb precursors 91 on a conveyor 93 with intact skin 92.

FIG. 10 shows an extruded mass 81 prepared using a die of the invention being cut by a cutting apparatus 101 to form extruded honeycomb precursors 91.

Any numerical values recited in the above application include all values from the lower value to the upper value in increments of one unit provided that there is a separation of at least 2 units between any lower value and any higher value. As an example, if it is stated that the amount of a component or a value of a process variable such as, for example, temperature, pressure, time and the like is, for example, from 1 to 90, preferably from 20 to 80, more preferably from 30 to 70, it is intended that values such as 15 to 85, 22 to 68, 43 to 51, 30 to 32 etc. are expressly enumerated in this specification. For values which are less than one, one unit is considered to be 0.0001, 0.001, 0.01 or 0.1 as appropriate. These are only examples of what is specifically intended and all possible combinations of numerical values between the lowest value, and the highest value enumerated are to be considered to be expressly stated in this application in a similar manner. Unless otherwise stated, all ranges include both endpoints and all numbers between the endpoints. The use of “about” or “approximately” in connection with a range applies to both ends of the range. Thus, “about 20 to 30” is intended to cover “about 20 to about 30”, inclusive of at least the specified endpoints. The term “consisting essentially of” to describe a combination shall include the elements, ingredients, components or steps identified, and such other elements ingredients, components or steps that do not materially affect the basic and novel characteristics of the combination. The use of the terms “comprising” or “including” to describe combinations of elements, ingredients, components or steps herein also contemplates embodiments that consist essentially of the elements, ingredients, components or steps. Plural elements, ingredients, components or steps can be provided by a single integrated element, ingredient, component or step. Alternatively, a single integrated element, ingredient, component or step might be divided into separate plural elements, ingredients, components or steps. The disclosure of “a” or “one” to describe an element, ingredient, component or step is not intended to foreclose additional elements, ingredients, components or steps.

What is claimed is:

1. An article comprising:
a) a die core having a plurality of flow paths adapted to flow extrudable material to a plurality of slots and around a plurality of pins so as to form a honeycomb structure from the extrudable material, the honeycomb structure having a skin about its outer surface in the extrusion direction, the slots comprise wall slots for forming walls of the honeycomb structure and skin slots disposed about an outer periphery of the die core for forming the skin about the honeycomb structure, a flange about a periphery of the die core, the die core having an extrusion entrance surface and an extrusion exit surface;
b) a mounting plate adapted to hold the die core in an extrusion system having an opening adapted to allow the extrudable material passed through the die core to exit the die core, an outer portion adapted to mount and hold the die core in place, and a flange about the periphery of the opening which seats the die core and is disposed to partially form the skin slots adapted to allow extrudable material to flow from the skin slots to form the skin about the outer surface of the honeycomb structure; and
wherein when the die core and the mounting plate are assembled, the flange about the periphery of the die core abuts the flange about the periphery of the opening of the mounting plate; and
wherein the die core and the surface of the mounting plate that form the skin, are comprised of different materials having different wear properties.

2. An article according to claim 1, wherein the surface of the mounting plate that forms the skin exhibits a surface roughness, as defined by the density of summits, of about 10 percent less than the surface roughness of the die core material.

3. An article according to claim 1, wherein the die core comprises hardened tool steel, tungsten carbide, or titanium carbide and the mounting plate comprises stainless steel, tungsten carbide, or titanium carbide.

4. An article according to claim 3, wherein the die core comprises hardened tool steel, and the surface in the mounting plate, which forms the skin, comprises stainless steel, tungsten carbide, titanium carbide, or a ceramic material.

5. An article according to claim 1, wherein the mounting plate has a coating disposed on its outer surface.

6. An article according to claim 1, wherein the mounting plate has a coating disposed on the flow surface which forms the outer skin surface wherein the coating comprises one or more of a metal, metal alloy, polymer and ceramic material.

7. An article according to claim 1, wherein the mounting plate comprises a separate part which is in contact with the extrudable material.

8. An article according to claim 7, wherein the mounting plate comprises a separate part which is in contact with the extrudable material and wherein the separate part comprises a single material and the single material comprises stainless steel, tungsten carbide or titanium carbide.

9. An article according to claim 1, wherein the mounting plate has a coating disposed on its outer surface wherein the coating exhibits a thickness of about 0.0002 inches (0.005 mm) to about 0.005 inches (0.013 mm).

10-16. (canceled)

17. An article comprising:
a) a die core including an extrusion entrance surface and an extrusion exit surface and having a plurality of flow paths adapted to flow extrudable material to a plurality of slots and around a plurality of pins so as to form a honeycomb structure from the extrudable material; the die core including:
i) a flange about a periphery of the die core;
ii) skin slots disposed about an outer periphery of the die core for forming a skin about the honeycomb structure;
iii) wall slots disposed inside of the skin slots for forming walls of the honeycomb structure; and
b) a mounting plate adapted to hold the die core in an extrusion system; the mounting plate including:
i) an opening adapted to allow the extrudable material passed through the die core to exit the die core;
ii) an outer portion adapted to mount and hold the die core in place;
iii) a flange about a periphery of the opening which seats the die core and is disposed to partially form the skin slots adapted to allow extrudable material to flow from the skin slots to form the skin about the outer surface of the honeycomb structure;
wherein when the die core and the mounting plate are assembled, the flange about the periphery of the die core abuts the flange about the periphery of the opening of the mounting plate;
wherein a skin flow surface of the mounting plate in cooperation with outside pins of the die core forms the skin of the honeycomb structure in the extrusion direction; and
wherein the die core and the surface of the mounting plate which forms the skin are comprised of different materials having different wear properties.

18. An article according to claim 17, wherein a surface of the mounting plate has a lower surface roughness than a surface of the die core material.

19. An article according to claim 17, wherein the surface of the mounting plate that forms the skin flow surface has a lower surface roughness than a surface of the die core material.

20. An article according to claim 17, wherein a difference in the surface roughness between the die core material and the surface roughness of the skin flow surface of the mounting plate is about 25 percent or greater.

21. An article according to claim 20, wherein a difference in the surface roughness between the skin flow surface of the mounting plate and the surface roughness of the die core material is about 90 percent or less.

22. An article according to claim 17, wherein the die core comprises hardened tool steel and the surface of the mounting plate which forms the skin comprises tungsten carbide.

23. An article according to claim 17, wherein the die core comprises hardened tool steel and the surface of the mounting plate which forms the skin comprises titanium carbide.

24. An article according to claim 17, wherein the skin flow surface is parallel to a plane formed by a surface of the outside pins.

25. An article according to claim 17, wherein the flange about the periphery of the die core has a surface parallel to an extrusion face of the die core which is recessed so as to cooperate with the mounting plate flange.

26. An article according to claim 17, wherein the skin flow surface is disposed about the periphery of the opening in the mounting plate parallel to an extrusion direction and perpendicular to the die core exit surface.

27. An article according to claim 17, wherein the wall and skin slots are of different thickness.
